(19) United States
(12) Patent Application Publication
(10) Pub. No.: US 2002/0156231 A1
(43) Pub. Date: Oct. 24, 2002

(54) Electron-transport and hole-transport polyimide films

(76) Inventors: Geoffrey A. Lindsay, Ridgecrest, CA (US); Richard A. Hollins, Ridgecrest, CA (US); John D. Stenger-Smith, Ridgecrest, CA (US); Peter Zarras, Ridgecrest, CA (US)

Correspondence Address: NAVAIRWD, COUNSEL GROUP (CODE K0000D), 1 ADMINISTRATION CIRCLE, CHINA LAKE, CA, 93555-6100, US

(21) Appl. No.: 09/840,682

(22) Filed: Apr. 20, 2001

(51) Int. Cl. C08G 73/10

(52) U.S. Cl. 528/353; 528/125; 528/126; 528/128; 528/171; 528/172; 528/173; 528/174; 528/175; 528/176; 528/179; 528/183; 528/188; 528/220; 528/229; 528/350; 528/351; 528/170; 428/411.1; 428/473.5

(57) ABSTRACT

An electronically active film comprising a compound of the formula:

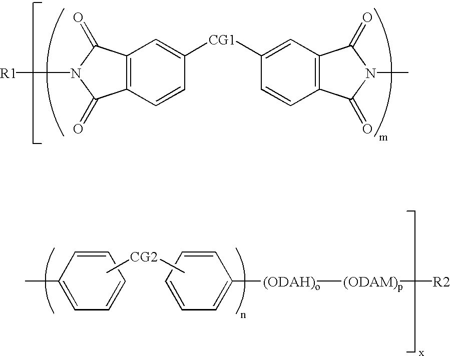

In a preferred embodiment of the invention, CG1 and CG2 are independently electron-transport or hole-transport groups; x is an integer from about 3 to about 3000; ODAH is a dianhydride residue; ODAM is a diamine residue; and m, n, o, and p cumulatively add to 1.0, with the sum of m and n ranging from about 0.05 to about 1.0, the sum of o and p ranging from about 0 to about 0.95, the sum of m and o being about 0.5 and the sum of n and p being about 0.5. A process for manufacturing the film and a device containing the film structure also are disclosed.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor.

### BACKGROUND

1. Field of the Invention

The present invention relates to a polyimide compound structure used in thin films. More particularly, the invention relates to thin films made from a compound formula having strong electron-transport and/or hole-transport properties. The thin films may be used in electroluminescent devices, electro-optic devices, such as cladding film layers in an optical modulator, and photo-refractive devices.

2. Description of the Related Art

Several compound structures for thin films having electron-transport or hole-transport properties are known. However, these thin film compound structures are generally limited to small molecules, for example less than 1000 Daltons in molecular weight which form brittle films. Suitable compounds for flexible thin films should provide a substantially amorphous polymeric material with adequate conductivity of electrons and/or holes, that additionally provide thermal stability with such characteristics as “tunable” conductivity, index of refraction, and polarity, adhesion to substrates, crosslinkability for resistance to solvents, in addition to being easily processed into thin films.

Many materials have some, but not a sufficient number of these characteristics. Common transport materials include small molecules that are made into films by an evaporative sublimation process, such as electron-transport materials incorporating tris(8-hydroxy)-quinoline (Alq3), or hole-transport materials incorporating triphenyldiamine derivative (TPD) (see G. E. Jabbour, et al, Elec. Lett 1997, v. 33 (24), p. 2070). Films of Alq3 and TPD must be laid down by an evaporation technique requiring expensive equipment and the film quality is difficult to reproduce (see G. E. Jabbour, et al., Appl. Phys. Lett. 1997, v. 71 (13), p. 1762; S. Tokito, et al., Appl. Phys. Lett 1997, v. 70 (15), p. 1929; R. H. Jordan, et al., Appl. Phys. Lett 1997, v. 69 (14), p. 1997; and S. A. Van Slyke, et al., Appl. Phys. Lett 1996, v. 69 (15), p. 2160). Furthermore, these small molecules tend to form crystals upon aging which change the performance characteristics of the device. One popular hole-transport material is poly(vinylcarbazole) (PVK). PVK is easily attacked by solvent used in fabricating other layers which must be placed on top of the PVK layer. Similar polymers are known to have little resistance to heat and solvent attack (e.g., E. S. Kolb, et al, Macromolecules 1996, v. 29, p. 2359). An example of a typical electron-transport polymer is poly(phenyl quinoxaline) (PPQ). PPQ suffers from solvent attack and adhesion problems.

Structures of thin films and the process for forming the film have been disclosed in U.S. Pat. No. 5,231,329 issued to Nishikitani et al. on Jul. 27, 1993 and U.S. Pat. No. 5,540,999 issued to Yamamoto et al. on Jul. 30, 1996, incorporated herein by reference. These patents neither disclose the polyimide polymer structure of the present invention, nor do these patents disclose the advantages of the presently described structure.

There is a need for materials that provide adequate conductivity of electrons and/or holes in amorphous thin-film form. Additionally, it is preferable that these materials provide thermal stability with such characteristics as a “tunable” index of refraction, polarity, adhesion to substrates, crosslinkability for resistance to solvents, and that are also easily processed into thin films. The present invention addresses these needs.

### SUMMARY AND OBJECTS OF THE INVENTION

An object of a preferred embodiment of the present invention is to provide a thin film comprising a compound of the formula:

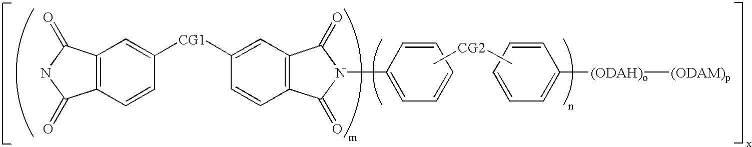

CG1 and CG2 are independently electron-accepting or electron-donating groups; x is an integer from about 3 to about 3000; ODAH is a dianhydride residue; ODAM is a diamine residue; and m, n, o, and p cumulatively add to 1.0, with the sum of m and n ranging from about 0.05 to about 1.0, the sum of o and p ranging from about 0 to about 0.95, the sum of m and o being about 0.5 and the sum of n and p being about 0.5.

Another object of a preferred embodiment of the present invention provides a process for manufacturing a thin film comprising the steps of providing a compound of the formula:

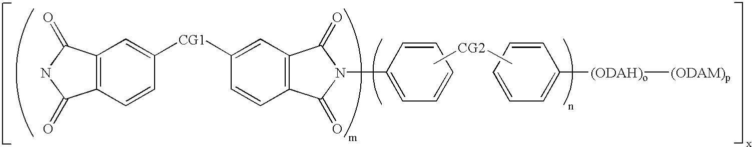

CG1 and CG2 are independently electron-accepting or electron-donating groups; x is an integer from about 3 to about 3000; ODAH is a dianhydride residue; ODAM is a diamine residue; and m, n, o, and p cumulatively add to 1.0, with the sum of m and n ranging from about 0.05 to about 1.0, the sum of o and p ranging from about 0 to about 0.95, the sum of m and o being about 0.5 and the sum of n and p being about 0.5; and, depositing the compound into a thin film. Then, depositing the compound into a film onto a substrate.

Additionally, a preferred embodiment of the present invention includes a device comprising a thin film having at least one layer of a polymer compound of the formula:

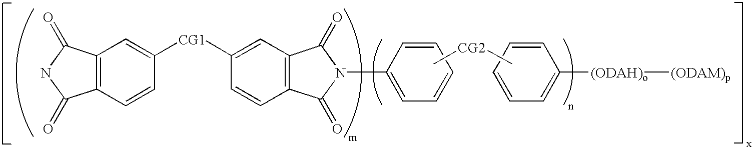

CG1 and CG2 are independently electron-accepting or electron-donating groups; x is an integer from about 3 to about 3000; ODAH is a dianhydride residue; ODAM is a diamine residue; and m, n, o, and p cumulatively add to 1.0, with the sum of m and n ranging from about 0.05 to about 1.0, the sum of o and p ranging from about 0 to about 0.95, the sum of m and o being about 0.5 and the sum of n and p being about 0.5.

Another object of a preferred embodiment of the present invention provides a material with adequate conductivity of electrons and/or holes, which is easily processed into amorphous thin-film form.

Another object of a preferred embodiment of the present invention provides a thin film with thermal stability, a “tunable” index of refraction, polarity, adhesion to substrates and crosslinkability for resistance to solvents.

### DETAILED DESCRIPTION OF THE INVENTION

A preferred embodiment of the present invention includes a thin film, generally an electron-transfer or hole-transfer film, comprising a polyimide compound of the formula:

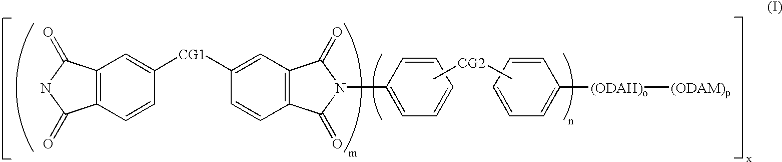

CG1 and CG2 are independently electron-accepting or electron-donating groups; x is an integer from about 3 to about 3000; ODAH is a dianhydride residue; ODAM is a diamine residue; and m, n, o, and p cumulatively add to 1.0, with the sum of m and n ranging from about 0.05 to about 1.0, the sum of o and p ranging from about 0 to about 0.95, the sum of m and o being about 0.5 and the sum of n and p being about 0.5.

In a preferred embodiment of the present invention the polyimide comprises more than one CG1 unit and/or more than one CG2 unit, representing a plethora different monomer units of the formula. A process for manufacturing a film comprises providing the compound of the formula and depositing the compound into an electronically active film. Devices containing the polyimide thin film structures of the present invention also are described.

A preferred embodiment of the present invention includes thin films that are useful in the manufacture of electronically active films, such as various transfer and/or display devices, e.g. light-emitting or electroluminescent, and electrophotographic and other such devices. The present invention may provide polyimide compound structures used as cladding layers in an optical modulator, and other similar uses. The present invention provides a substantially amorphous polymeric material that has adequate conductivity of electrons in one embodiment, adequate conductivity of holes in a second embodiment, and both electron-transport and hole-transport combination in a third embodiment. The films of the present invention are easily processed into thin films that thermal stable, as well as having a “tunable” index of refraction, adhesion to substrates, and crosslinkability for resistance to solvents.

In a more preferred embodiment, the polyimide compounds, shown in formula (I) above, comprise electron-accepting groups, or electron-transport (ET) properties. CG1 and CG2 are large aromatic groups, which are strongly electron-accepting. The formula in such polyimide structures has a strong electron-accepting group represented by at least one of CG1 and CG2, preferably CG2, which preferably has the strong electron-accepting structure of:

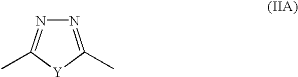

or the structure of:

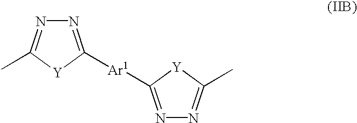

In this preferred embodiment, Y is an oxygen (O) or sulfur (S), preferably O, and Ar¹ is a phenyl, biphenyl, naphthyl, or other similar aromatic group.

In another more preferred embodiment, the polyimide compounds, shown in formula (I) above, comprise electron-donating groups, or hole-transport (HT) properties. CG1 and CG2 are large aromatic groups, which are strongly electron-donating. The formula in such polyimide structures has a strong electron-donating group represented by at least one of CG1 and CG2, preferably CG2, which preferably has the strong electron-accepting structure of:

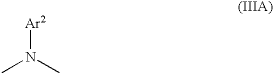

or the structure of:

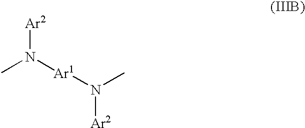

Ar¹ is a phenyl, biphenyl, naphthyl, or other similar aromatic group, and Ar² is a phenyl, biphenyl, naphthyl, or other similar aromatic group, and may be substituted with an alkyl, preferably a C1-C22 alkyl, or alkoxy group, preferably a C1-C22 alkoxy. Preferably, Ar¹ is a phenyl.

Other embodiments of the present invention include the above described formula (I) having a hole-transport group and an electron-transport group replacing at least one of CG1 and CG2, preferably CG2. More preferably, the above described formula (I) has at least two of CG1 and/or CG2. In another embodiment, two CG2 are replaced by at least one of the structures represented in each of formulas IIA, IIB, IIIA and IIIB, above.

ODAH and ODAM of formula (I) are neither strong electron-donating nor strong electron-accepting groups. These groups may be added to enhance or fine-tune certain other properties of the film, such as refractive index and glass transition temperature. The fine-tuning of the film by selection of these units may be experimentally defined, and determinable by one of ordinary skill in the art. Representative examples of the units non-exclusively include co-monomer structures such as:

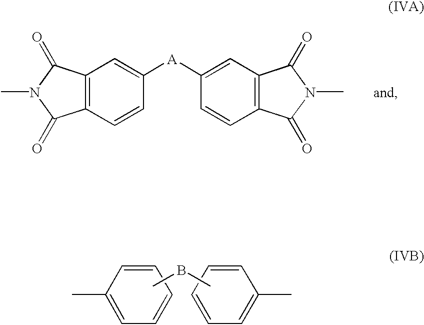

A and B non-exclusively represent such groups as —O—, —S—, —S(O)₂—, —C(O)—, —C(O)—O—(CH₂)ₙ—O—C(O)—, —C(CF₃)₂—, —C(CH₃)₂—, —C(Ar)(CF₃)—, —P(O)(Ar)—, and —O—(CH₂)ₙ—O—, where n is an integer that may range from about 1 to about 12, and Ar represents an aryl group. Representative examples also include dianhydride derivatives such as:

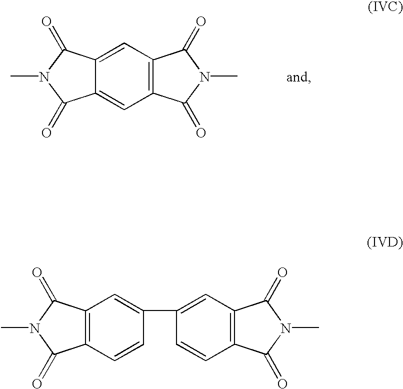

and other like dianhydride derivatives, and diamine derivatives such as:

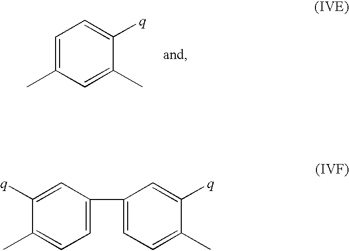

and other like diamines, where q may be OH, SH, halogen, alkyl and/or alkoxy groups. Co-monomer structures, such as that shown in formulas IVE and IVF, are desirable in crosslinking applications of the present invention. In a preferred embodiment of the invention, more than one diamine or more than one dianhydride is used. In that preferred embodiment, each diamine or dianhydride is randomly distributed along the chain with dianhydrides attached to diamines and vice versa.

Also within the scope of the present invention, the film further comprises additional types of co-monomers. The amount of co-monomer imparting either ET or HT properties in the film may be varied as a percentage of the bulk or total polymer material. The amount of the co-monomer imparting either ET and/or HT properties in the film may be any amount effective to impart a desirable characteristic into the film. For example, from about 5 mole percent to about 100 mole percent, about 20 mole percent to about 60 mole percent, about 40 mole percent to about 50 mole percent, etc., with the optimal percentage of co-monomer imparting either ET or HT properties in the film, which is determinable by those skilled in the art. In situations where a higher electrical conductivity is desired for a given application, a higher percentage of ET or HT groups is used. By lowering the percentage amount of ET or HT groups in the polymer, additional monomer units may be added for imparting certain characteristics, such as increasing the solubility of the polymer, increasing adhesion to a substrate and crosslinking, tuning the index of refraction and/or glass transition temperature, and/or lowering the dielectric constant. In general, increasing the amount of fluorinated units, such as —C(CF₃)₂— and —C(Ar)(CF₃)—, will decrease the index of refraction, and increasing the amount of flexible units, such as —C(O)—O—(CH₂)ₙ—O—C(O)— and —O—(CH₂)ₙ—O—, will decrease the glass transition temperature, T_{g}.

The polyimide formula (I) of the present invention has a range of x sufficient to impart strength and flexibility to the film, with the range of x determinable by those skilled in the art for a given application. Generally for most applications x ranges preferably from about 3 to about 3000, more preferably from about 3 to about 700, and most preferably from about 10 to about 500. With x in excess of 3000, viscosity of the polyimide of the present invention in a solvent is unacceptably high.

The process for manufacturing an electro-optic film comprises the steps of providing a compound of the formula:

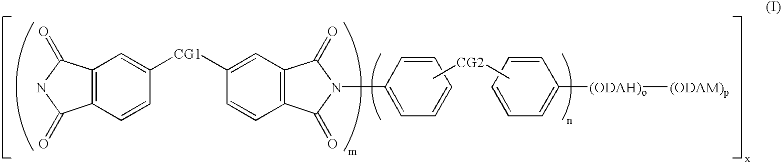

CG1 and CG2 are independently electron-accepting or electron-donating groups; x is an integer from about 3 to about 3000; ODAH is a dianhydride residue; ODAM is a diamine residue; and m, n, o, and p cumulatively add to 1.0, with the sum of m and n ranging from about 0.05 to about 1.0, the sum of o and p ranging from about 0 to about 0.95, the sum of m and o being about 0.5 and the sum of n and p being about 0.5 as described above; and, depositing the compound into an electronically active film. Solvents used with the polyimide compound of the present invention non-exclusively include N-methyl pyrrolidinone (NMP), dimethylformamide (DMF), diglyme, ethyl lactate, and other solvents that permit proper thin film formation. Methods for depositing the film include commonly known methods known in the art, such as casting and spin-coating, with the appropriated method for a given application determinable by those skilled in the art.

The present invention further comprises a device comprising a thin film having at least one layer with monomer units of the compound formula:

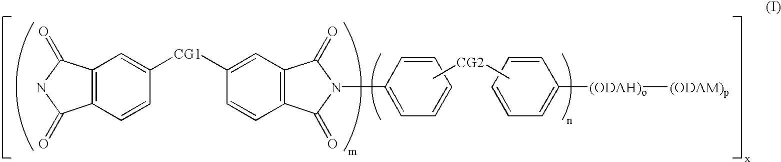

CG1 and CG2 are independently electron-accepting or electron-donating groups; x ranges from about 3 to about 3000; ODAH is a dianhydride residue; ODAM is a diamine residue; and m, n, o, and p cumulatively add to 1.0, with the sum of m and n ranging from about 0.05 to about 1.0, the sum of o and p ranging from about 0 to about 0.95, the sum of m and o being about 0.5 and the sum of n and p being about 0.5 as described above. Depending on the use of the device, the film may comprise only ET groups at the CG1 and/or CG2 positions, only HT groups at the CG1 and/or CG2 positions, or a combination of ET and HT groups at the CG1 and/or CG2 positions. The films that contain only ET or only HT groups may be considered electrical diodes. In the ET polymer compositions, mobility of the electrons is high and mobility of holes is lower. In HT polymer compositions, the mobility of holes is high, and the mobility of electrons is lower. Applications for having both ET and HT groups in the same polyimide film include when charge-transfer complexes or related electronically excited states are required in the bulk material to provide a trap or a light-emitting group. The determination of using only ET groups or HT groups, or a combination of ET and HT groups for a given application is determinable by those of ordinary skill in the art.

Single or multiple layers of the ET layer, HT layer, and/or combination ET and HT layer may be formed. Generally, the film is incorporated in the device having the HT-containing film material placed nearest to the electrode that will accept electrons, and the ET-containing film material nearest the electrode that will donate electrons.

The thickness of the film layers may be varied. For example, in electrophotographic processes, the electron-transport layer is advantageously thicker than that of the hole-transport layer, in ranges of from about 5 to about 200 times, and particularly 10 to 40 times. Useful thicknesses for the electron-transfer layer are within the range of from about 0.1 to about 15 mm dry thickness, particularly from about 0.5 to about 2 mm. However satisfactory results may also occur having an electron-transfer layer that is thinner than the hole-transfer layer. For applications, such as electroluminescent devices, the layer thickness typically ranges from about 50 angstroms to about 10,000 angstroms, more preferably in the range of from about 500 angstroms to about 1500 angstroms, with the optimal layer thickness for a given application determinable by those skilled in the art.

The following examples illustrate the preparation of the compound and manufacture of thin films of the present invention.

### Preparation of the Polyimide Compositions

The polyimide compositions of the present invention are prepared by normal polymerization procedures. For example, diamines and dianhydrides are stirred in a solvent for several hours at room temperature to form a resultant poly(amic acid). The temperature is increased to about 180° C. for several hours to complete the imidization reaction. Small amounts, approximately 1%, of monofunctional anhydrides and amines may be used in the polymerization solution is then poured into an excess of alcohol to precipitate the polymer and remove the solvent. The dissolution and precipitation process may be repeated several times to further purify the polymer.

### Preparation of the Thin Film

The polyimides compounds, as described above, are normally deposited into films by dissolving about 25 weight percent of the polyimide in a solvent, such as N-methyl pyrrolidinone (NMP), and casting a film of this solution on a solid substrate, such as a glass slide. The film is baked above the glass transition temperature of the polyimide to remove the solvent. The amic acid form of the polymer may also be used to cast a film from solution. The imidization is then accomplished in the solid state by heating the film to drive off the water of imidization. The films may be crosslinked by employing a polyimide containing a hydroxy phenyl unit in the backbone, and mixing a small amount of crosslinking agent in solution with the polyimide. The crosslinking agent may be a commercial diepoxy compound or dioxazalone compound. Crosslinked films are cured from about 180° C.-240° C., or above the glass transition temperature, whichever is higher, for approximately one hour in order to bring about the crosslinked reaction. In a preferred embodiment, the imide form of the polymer is used.

It should be understood that the foregoing summary, detailed description, and examples of the invention are not intended to be limiting, but are only exemplary of the inventive features which are defined in the claims.

What is claimed is:

1. A thin film comprising a compound of the formula: 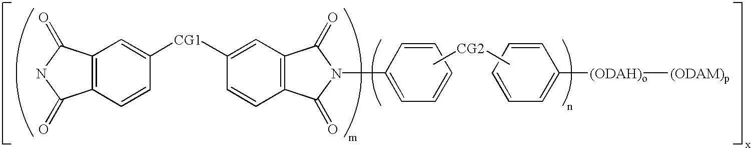
wherein CG1 and CG2 are idependently selected from the group consisting of an electron-transport group and a hole-transport group; x is an integer from about 3 to about 3000; ODAH is a dianhydride residue; ODAM is a diamine residue; and m, n, o, and p cumulatively add to 1.0, wherein the sum of m and n is about 0.05 to about 1.0, the sum of o and p is about 0 to about 0.95, the sum of m and o is about 0.5 and the sum of n and p is about 0.5.

2. The film of claim 1, wherein at least one of CG1 and CG2 comprises an electron-transport group.

3. The film of claim 2, wherein said electron-transport group comprises: 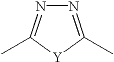
wherein Y is selected from the group consisting of O and S.

4. The film of claim 3, wherein Y comprises O.

5. The film of claim 2, wherein said electron-transport group comprises: 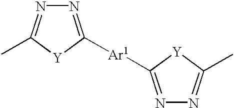
wherein Y is selected from the group consisting of O and S, and Ar¹ comprises an aromatic group.

6. The film of claim 5, wherein Y comprises O.

7. The film of claim 5, wherein Ar¹ comprises diphenyl.

8. The film of claim 1, wherein at least one of CG1 and CG2 comprises a hole-transport group.

9. The film of claim 8, wherein said hole-transport group comprises: 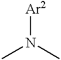
wherein Ar² is an aromatic group.

10. The film of claim 8, wherein said hole-transport group comprises: 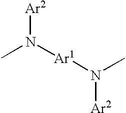
wherein Ar¹ comprises an aromatic group and Ar² comprises an aromatic group.

11. The film of claim 1, wherein said ODAM is selected from the group consisting of: 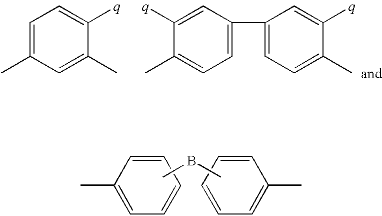
wherein B is selected from the group consisting of O, S, S₂, SO₂, CO, CO—O—(CH₂)ₙ—O—CO, C(CF₃)₂, C(CH₃)₂, C(Ar)CF₃, PO(Ar), and O—(CH₂)ₙ—O, wherein n is an integer from about 1 to about 12, Ar is an aryl group, and q is selected from the group consisting of OH, SH, a halogen, an alkyl and an alkoxy.

12. The film of claim 1, wherein said ODAH is selected from the group consisting of: 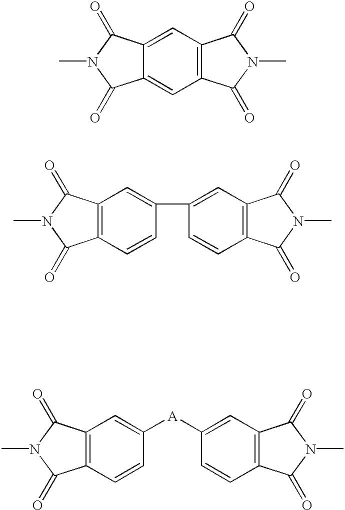
wherein A is selected from the group consisting of O, S, SO₂, CO, CO—O—(CH₂)ₙ—O—CO, C(CF₃)₂, C(CH₃)₂, C(Ar)CF₃, PO(Ar), and O—(CH₂)ₙ—O, wherein n is an integer from about 1 to about 12, and Ar is an aryl group, and q is selected from the group consisting of OH, SH, a halogen, an alkyl and an alkoxy.

13. The film of claim 10, wherein Ar¹ comprises phenyl.

14. The film of claim 1, wherein said formula comprises both electron-transport groups and hole-transport groups.

15. A process for manufacturing a film comprising the steps of:
providing a compound of the formula: 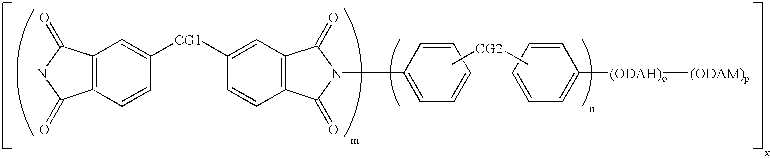
wherein CG1 and CG2 are independently selected from the group consisting of an electron-transport group and a hole-transport group; x is an integer from about 3 to about 3000; ODAH is a dianhydride residue; ODAM is a diamine residue; and m, n, o, and p cumulatively add to 1.0, wherein the sum of m and n is about 0.05 to about 1.0, the sum of o and p is about 0 to about 0.95, the sum of m and o is about 0.5 and the sum of n and p is about 0. 5;
and,
depositing said compound into a film.

16. A device comprising a film having at least one layer with the formula: 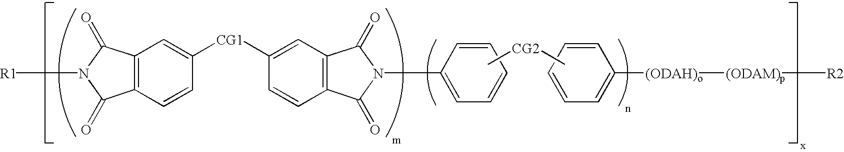
wherein CG1 and CG2 are independently selected from the group consisting of an electron-transport group and a hole-transport group; x is an integer from about 3 to about 3000; ODAH is a dianhydride residue; ODAM is a diamine residue; and m, n, o, and p cumulatively add to 1.0, wherein the sum of m and n is about 0.05 to about 1.0, the sum of o and p is about 0 to about 0.95, the sum of m and o is about 0.5 and the sum of n and p is about 0.5.
